(19) United States
(12) Patent Application Publication
(10) Pub. No.: US 2012/0229584 A1
(43) Pub. Date: Sep. 13, 2012

(54) PRINTER CONTROL METHOD AND PRINTER DRIVER

(75) Inventors: Shingo Yudasaka, Suwa-shi (JP); Toshiyuki Sugimoto, Suwa-shi (JP)

(73) Assignee: SEIKO EPSON CORPORATION, Shinjuku-ku (JP)

(21) Appl. No.: 13/414,127

(22) Filed: Mar. 7, 2012

(30) Foreign Application Priority Data
Mar. 8, 2011 (JP) 2011-050161

(51) Int. Cl. B41J 2/01

(52) U.S. Cl. 347/104

(57) ABSTRACT

A printer control method and printer driver enable printing efficiently and improving work efficiency while also enabling high precision printing. A method of controlling a printer 1 that, when printing print data received from a host computer 80 to recording paper, pulls the back side of the printed surface of the recording paper that is printed to the vacuum platen side by a vacuum fan 35, including a step of : setting a delay time until stopping operation of the vacuum fan 35 after printing ends based on input from a control unit 81, which is a printer driver installed on the host computer 80.

### BACKGROUND

1. Technical Field

The present invention relates to a control method and a printer driver for a printer that pulls recording paper to a platen while conveying the paper.

2. Related Art

In order to print with good precision, preventing the recording paper from separating from the platen surface and stabilizing the position of the paper surface is important in inkjet printers that print by ejecting ink droplets onto the recording paper. Addressing this problem, printers that pull and hold the recording paper conveyed over the platen surface to the platen by means of air suction produced with a fan are also known from the literature. See, for example, Japanese Unexamined Patent Appl. Pub. JP-A-2010-36442, Japanese Unexamined Patent Appl. Pub. JP-A-2009-7088, and PCT Pub. No. WO00/34049.

To reduce noise and power consumption, business printers stop operation of the recording paper vacuum fan disposed to the platen after printing is completed. However, if printing is requested while the fan is stopped, the recording paper vacuum fan must be restarted, and the start of actual printing is delayed several seconds. This delay does not occur when printer requests are issued continuously because fan operation is not stopped and the fan operates continuously. However, when printer requests are issued intermittently, the recording paper vacuum fan stops and starts with each print request, and throughput does not increase.

A printer control method and printer driver according to the present invention enable printing efficiently and improving work efficiency while also enabling high precision printing.

### SUMMARY

One aspect of the invention is a method of controlling a printer that, when printing print data received from a host computer to paper, pulls the side of the paper on the opposite side as the side that is printed to the platen side by means of a vacuum fan, the control method including a step of setting a delay time until stopping operation of the vacuum fan after printing ends based on input from an external source.

The control method according to this aspect of the invention enables freely setting the delay time until the vacuum fan stops operating according to the working conditions of the printer. As a result, the user can shorten the delay time to fit the user's work, and thereby suppress fan noise and power consumption by the vacuum fan. In addition, if the user increases the delay time, the startup time required for the vacuum fan to resume operating when printing starts can be eliminated and throughput can be improved.

Printing can thus be done efficiently, work efficiency can be greatly improved, and the paper can be pulled to the platen side when printing to enable printing with high precision.

In a printer control method according to another aspect of the invention, printing starts without stopping operation of the vacuum fan when a print request is received from the host computer during the delay time.

This control method enables eliminating the startup time required for the vacuum fan to resume operation when printing starts, and improves throughput.

In a printer control method according to another aspect of the invention, the operating speed of the vacuum fan is slower during the delay time than when printing.

This control method enables minimizing the noise and power consumption of the vacuum fan during the delay time.

A printer driver according to another aspect of the invention is printer driver for configuring a printer that, when printing print data received from a host computer to paper, pulls the side of the paper on the opposite side as the side that is printed to the platen side by a vacuum fan, the printer driver enabling setting a delay time until stopping operation of the vacuum fan after printing ends.

This aspect of the invention enables freely setting the delay time until the vacuum fan stops operating according to the printing conditions. As a result, the user can shorten the delay time to fit the user' s work and thereby suppress fan noise and power consumption by the vacuum fan, or increase the delay time to eliminate the startup time required for the vacuum fan to resume operating when printing starts and improve throughput.

Printing can thus be done efficiently, work efficiency can be greatly improved, and the paper can be pulled to the platen side when printing to enable printing with high precision.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an external oblique view showing a preferred embodiment of a printer using the printer control method according to the invention.

FIG. 2 is an external oblique view of the printer in FIG. 1 with the cover open.

FIG. 3 is a section view of the printer in FIG. 1.

FIG. 4 is a partial oblique view of the vacuum platen and recording paper suction mechanism in the printer shown in FIG. 1.

FIG. 5 is a plan view of the vacuum platen when recording paper passes in the printer shown in FIG. 1.

FIG. 6 is an oblique view of the head cleaning mechanism of the printer in FIG. 1.

FIG. 7 is a section view of the head cleaning mechanism of the printer in FIG. 1 during a nozzle check.

FIG. 8 is a block diagram of the control system of the printer in FIG. 1.

FIG. 9 shows an example of a selection window presented on the display of a host computer.

FIG. 10 is a timing chart of control in the continuous mode.

FIG. 11 is a timing chart of control in the default mode.

FIG. 12 is a timing chart of control in the custom mode.

FIG. 13 is a timing chart of control in the custom mode in another embodiment of the invention.

### DESCRIPTION OF EMBODIMENTS

A preferred embodiment of a printer control method and printer driver according to the present invention is described below with reference to the accompanying figures.

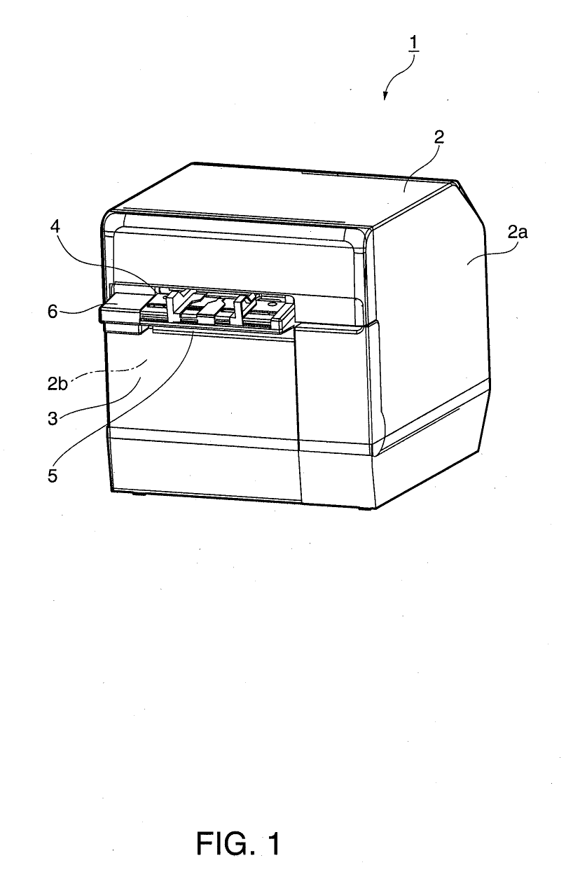

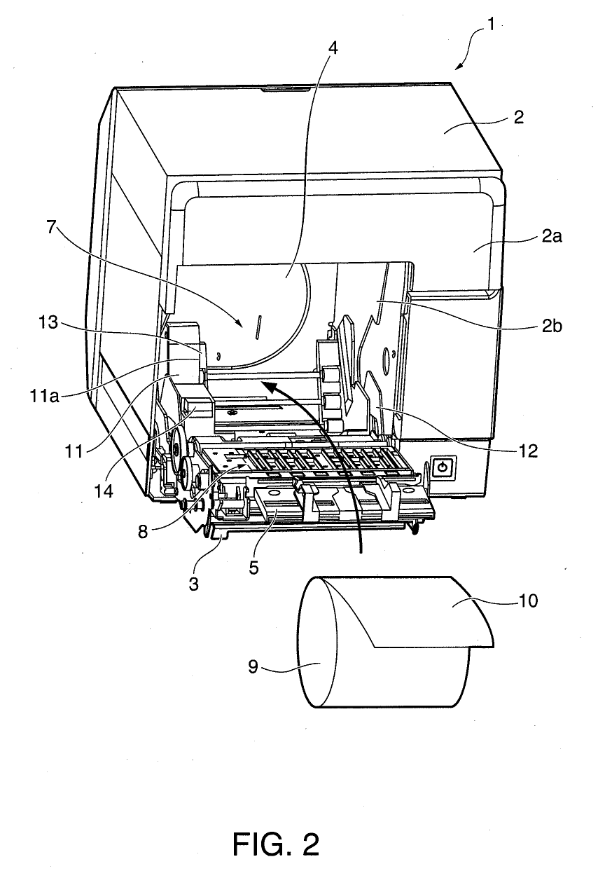

As shown in FIG. 1 and FIG. 2, the printer 1 according to this embodiment of the invention is a roll paper printer that prints to roll paper 9 as the recording paper. The printer 1 has a generally rectangular, box-shaped printer housing 2, and an access cover 3 attached to the front of the printer housing 2. A paper exit 4 of a specific width is formed in the front of the outside case 2a of the printer housing 2. A discharge guide 5 protrudes to the front below this paper exit 4, and a cover lock lever 6 is disposed beside the discharge guide 5. A rectangular opening 2b (see FIG. 2) for loading and unloading roll paper is formed in the outside case 2a below the discharge guide 5 and cover lock lever 6, and this opening 2b is closed by the access cover 3.

Operating the cover lock lever 6 unlocks the access cover 3. When the discharge guide 5 is then pulled forward, the access cover 3 opens to a substantially horizontal position pivoting on the bottom thereof as shown in FIG. 2. When the access cover 3 opens, the roll paper compartment 7 formed inside the printer housing 2 is open. The vacuum platen (platen) 8 that defines the printing position moves with the access cover 3, the recording paper conveyance path from the roll paper compartment 7 to the paper exit 4 opens, and the roll paper 9 can be replaced from the front of the printer housing 2.

The roll paper 9 is stored in the roll paper compartment 7 with the axis running widthwise to the printer. The roll paper compartment 7 has a first wall 11 and a second wall 12 on the left and right sides that determine the storage width, and the first wall 11 and second wall 12 can slide widthwise to the printer to accommodate roll paper 9 of different widths. A lock mechanism that prevents the first wall 11 from moving widthwise to the printer, and a roll paper urging member 13 are disposed to the first wall 11, and the operating part 14 of this lock mechanism protrudes from the front top part of the first wall 11. The distal end of the roll paper urging member 13 protrudes into the roll paper compartment 7 from an opening formed in the inside surface 11a of the first wall 11. The roll paper urging member 13 is configured to move between the protruding position shown in FIG. 2 and a retracted position where the end face of the distal end is flush with the inside surface 11a of the first wall 11, and is constantly urged to the protruding position by a specific elastic force.

When the operating part 14 is manually depressed, the first wall 11 is unlocked and the first wall 11 can be moved widthwise to the printer and positioned to the paper width of the roll paper 9 to be loaded. When the operating part 14 is then released, the lock engages again to prevent movement of the first wall 11. When the roll paper 9 is loaded after adjusting the first wall 11 to the paper width, the roll paper urging member 13 pushes the roll paper 9 to the second wall 12 side, thus preventing the loaded roll paper 9 from moving sideways. Note that the cover case 3a of the access cover 3 and the cover lock lever 6 are not shown in FIG. 2.

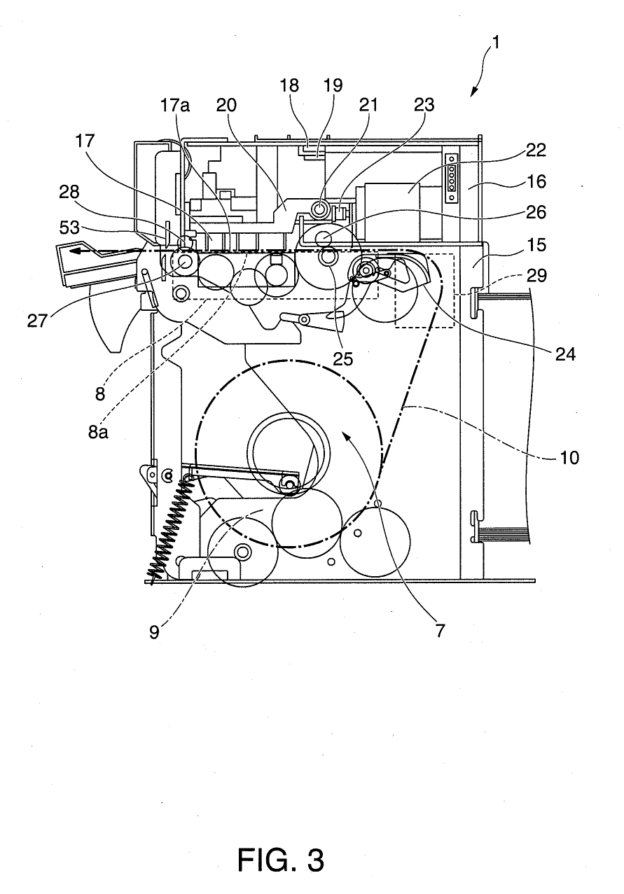

As shown in FIG. 3, the roll paper compartment 7 is formed in the middle of the width of the main printer frame 15 inside the printer 1. A head unit frame 16 is attached horizontally to the top of the main printer frame 15 above the roll paper compartment 7. Disposed to the head unit frame 16 are an inkjet head 17, a linear scale 18 and encoder sensor 19 for detecting the position of the inkjet head 17, a carriage 20 that carries the inkjet head 17 and encoder sensor 19, and a carriage guide shaft 21 that guides movement of the carriage 20 widthwise to the printer.

The inkjet head 17 is mounted on the carriage 20 with the nozzle face 17a facing down. The carriage guide shaft 21 extends horizontally widthwise to the printer. Also disposed to the head unit frame 16 is a carriage conveyance mechanism including a carriage motor 22 and timing belt 23 for moving the carriage 20 reciprocally along the carriage guide shaft 21.

The vacuum platen 8 is disposed horizontally widthwise to the printer below the inkjet head 17 with a specific gap therebetween. The vacuum platen 8 pulls the back side of the printed surface of the recording paper 10 to the platen surface 8a as the recording paper (paper) 10 delivered from the paper roll 9 passes the printing position. A recording paper suction mechanism is configured in the vacuum platen 8 and printer housing 2.

A tension guide 24 that curves down is disposed to the back end of the vacuum platen 8. The tension guide 24 is urged upward by the force of a spring, and the recording paper 10 pulled from the roll paper 9 stored in the roll paper compartment 7 is pulled through the recording paper conveyance path that passes the printing position with specific tension applied to the paper by the tension guide 24.

A rear paper feed roller 25 is disposed horizontally widthwise to the printer behind the vacuum platen 8. A rear pressure roller 26 of a specific width is pressed with a specific pressure to the rear paper feed roller 25 with the recording paper 10 therebetween. A front paper feed roller 27 is disposed to a position in front of the vacuum platen 8. A front pressure roller 28 is pressed from above to the front paper feed roller 27 with the recording paper 10 therebetween. The rear paper feed roller 25 and the front paper feed roller 27 are driven by a paper feed motor 29 mounted on the main printer frame 15.

A paper cutter 53 is disposed to the paper exit 4, and the recording paper 10 discharged from the paper exit 4 by the front paper feed roller 27 and front pressure roller 28 is cut by the paper cutter 53. The vacuum platen 8, tension guide 24, rear paper feed roller 25, and front paper feed roller 27 move with the access cover 3 when the access cover 3 opens and closes.

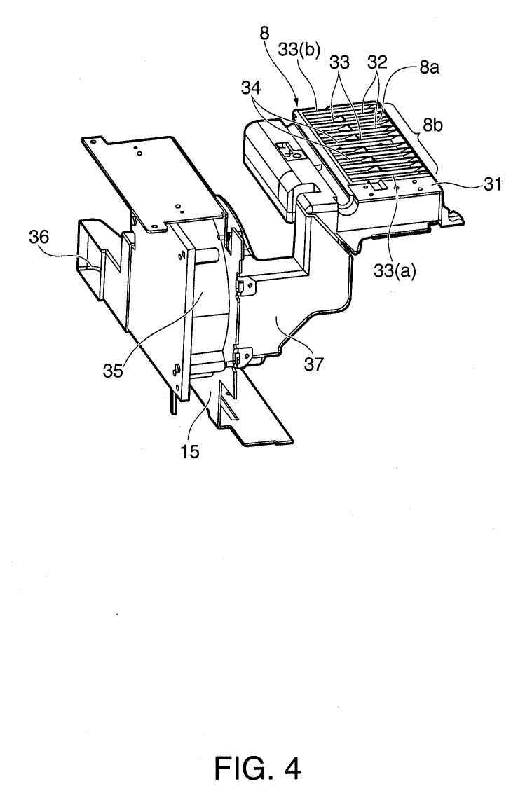

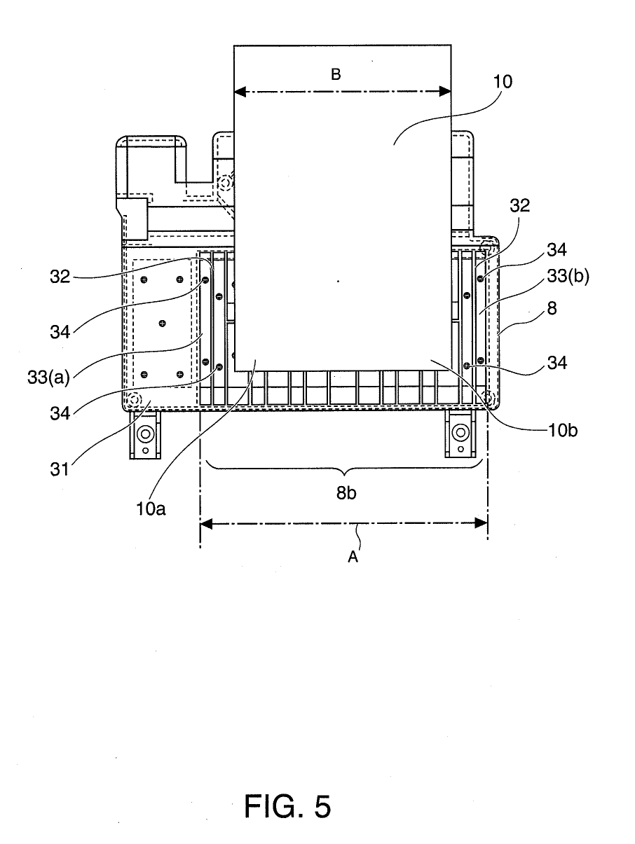

As shown in FIG. 4 and FIG. 5, the vacuum platen 8 is a flat rectangle disposed with the long side aligned with the printer width. An ink mist recovery unit 31 that recovers ink mist produced by ink droplets ejected from the inkjet head 17 is formed at the side of the vacuum platen 8 in unison with the vacuum platen 8. The surface 8a of the vacuum platen 8 is divided into a plurality of channel-like chambers 33 by a plurality of longitudinal ribs 32. The recording paper suction mechanism includes these plural chambers 33, suction holes 34 formed in the bottom of the plural chambers 33, a vacuum fan 35 affixed to the back panel of the main printer frame 15, and an air channel 37 that communicates through the suction holes 34 with each of the chambers 33 and communicates through the vacuum fan 35 with an exhaust vent 36 formed in the back of the printer housing 2.

The vacuum platen 8 and air channel 37 can be connected and disconnected from each other. The vacuum platen 8 disconnects from the air channel 37 when the access cover 3 opens because the vacuum platen 8 moves forward with the access cover 3. Because the vacuum platen 8 returns to the original position when the access cover 3 closes, the vacuum platen 8 also reconnects to the air channel 37. When the vacuum platen 8 and air channel 37 are connected and the vacuum fan 35 operates, air is pulled in from the suction holes 34 and the recording paper 10 conveyed over the surface 8a of the vacuum platen 8 is pulled to the surface 8a.

Note that the width of the vacuum platen 8 is aligned with the width of the printer, and the top openings of the chambers 33 render the suction area 8b of the vacuum platen 8. As shown in FIG. 5, the width A of the suction area 8b of the vacuum platen 8 is the width from the left end of the top opening of the chamber 33(a) at the left end of the vacuum platen 8 to the right end of the top opening of the chamber 33(b) at the right end. Paper width B of the recording paper 10 is the width of the recording paper 10 in the direction of the vacuum platen 8 width.

When printing, the printer 1 operates the vacuum fan 35 and pulls the recording paper 10 fed from the roll paper 9 to the suction area 8b of the vacuum platen 8. The printer 1 also repeats the operation that moves the inkjet head 17 across to the vacuum platen 8 and prints by moving the carriage 20 along the carriage guide shaft 21, and the operation that conveys the recording paper 10 a specific pitch in the direction perpendicular to the width of the vacuum platen 8 by rotationally driving the rear paper feed roller 25 and front paper feed roller 27.

Because part of the suction area 8b will be exposed outside the first and second paper edges 10a, 10b at the opposite sides of the recording paper 10 width B if the paper width B of the recording paper 10 used for printing is narrower than the width A of the vacuum platen 8 suction area 8b, air flow is produced near the first and second paper edges 10a, 10b by the suction of air through these exposed parts. This air flow disperses paper dust and and other particulate above the first and second paper edges 10a, 10b. Because the edges of the recording paper 10 are the paper fibers are cut, paper dust is easily produced. Furthermore, because this embodiment has first and second walls 11 and 12 that hold the roll paper 9 in the roll paper compartment 7 from the sides and prevent sideways movement, the ends of the roll paper 9 rub against the first and second walls 11 and 12 and produce paper dust every time the recording paper 10 is conveyed. This paper dust may be conveyed with the recording paper 10 from the roll paper compartment 7 to the vacuum platen 8.

As a result, when the recording paper 10 width B is narrower than the width A of the vacuum platen 8 suction area 8b, the printer 1 controls driving recording paper 10 conveyance so that the recording paper 10 is conveyed when the inkjet head 17 nozzle face 17a is at a position separated a specific distance from the first and second paper edges 10a, 10b so that paper dust and other foreign matter conveyed from the roll paper compartment 7 to the printing position does not disperse and adhere to the nozzle face 17a.

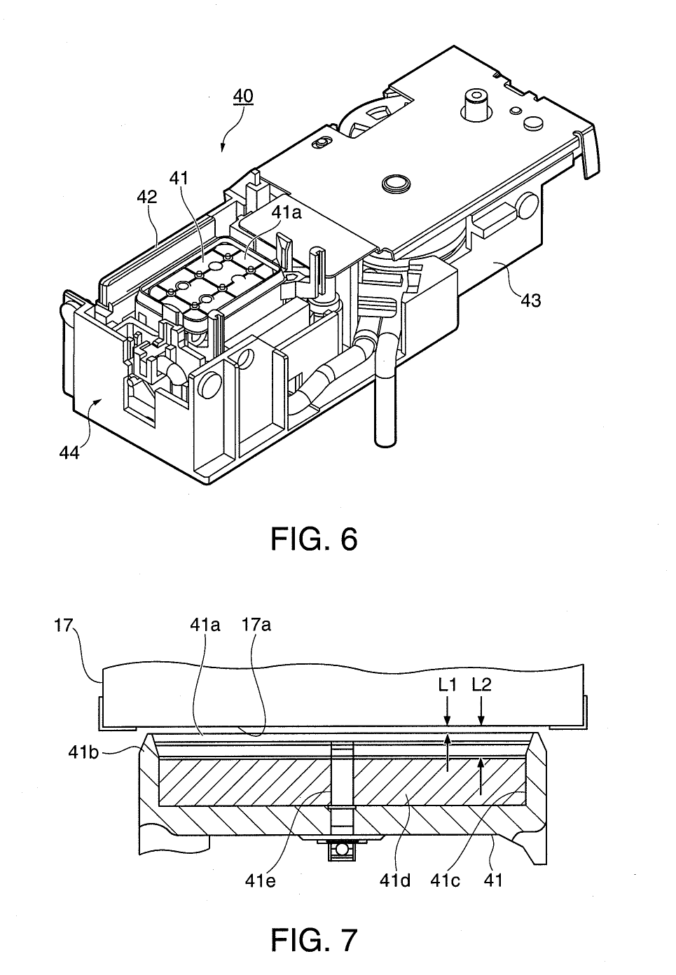

As shown in FIG. 6, the printer 1 has a head cleaning mechanism 40, and this head cleaning mechanism 40 is disposed below the standby position of the inkjet head 17. The head cleaning mechanism 40 includes a head cap 41 for capping the nozzle face 17a of the inkjet head 17, a wiper 42 for wiping ink and foreign matter sticking to the nozzle face 17a, and an ink vacuum unit 43 that vacuums ink left in or clogging the nozzles of the inkjet head 17. The head cap 41, wiper 42, and ink vacuum unit 43 are attached to the frame 44 of the head cleaning mechanism 40. The frame 44 is fastened to the main printer frame 15, which also supports the carriage guide shaft 21 and vacuum platen 8.

The head cap 41 is located directly below the nozzle face 17a in the standby position, and includes a capping face 41a facing up opposite the nozzle face 17a. The head cap 41 is configured slidably up and down perpendicularly to the nozzle face 17a, that is, perpendicularly to the carriage guide shaft 21, by operating a drive mechanism not shown. As a result, the head cap 41 moves in the direction causing the capping face 41a to move toward or away from the nozzle face 17a.

As shown in FIG. 7, the head cap 41 is made of rubber or other elastic material and has a box-like configuration with the edge part 41b of the capping face 41a rising vertically. The size and shape of the head cap 41 enable the head cap 41 to contact the nozzle face 17a while the edge part 41b surrounds the part of the nozzle face 17a where the nozzles are formed. A vacuum tube extending from a pump motor (not shown) of the ink vacuum unit 43 is connected to the inside of the cavity 41c enclosed by the capping face 41a and edge part 41b. When the edge part 41b is touching the nozzle face 17a and the pump motor operates, the suction produced by the pump motor reduces the pressure in the sealed space formed by the cavity 41c and nozzle face 17a, and ink left in the nozzles of the inkjet head 17 is vacuumed out and discharged into the cavity 41c.

The wiper 42 is a blade-like member made of rubber or other elastic material, and is supported slidably up and down by a guide member not shown fastened to the frame 44 of the head cleaning mechanism 40. Similarly to the head cap 41, the wiper 42 is configured so that it can move vertically to and away from the nozzle face 17a by operating a drive mechanism not shown. To wipe the nozzle face 17a with the wiper 42, the wiper 42 is raised until the distal end of the wiper 42 protrudes slightly above the elevation of the nozzle face 17a while the nozzle face 17a is offset horizontally from directly above the wiper 42, and the inkjet head 17 is then moved along the carriage guide shaft 21 so that the edge of the wiper 42 slides against the nozzle face 17a. Ink and foreign matter sticking to the nozzle face 17a is thus wiped off by the edge of the wiper 42.

When a print job ends and the inkjet head 17 is waiting in the standby position, the head cap 41 moves to a position where the edge part 41b contacts the surface around the nozzle face 17a and seals the nozzles. This inhibits the ink in the nozzles from increasing in viscosity and nozzles becoming clogged while waiting to print. The wiping process whereby the wiper 42 wipes the nozzle face 17a can also be performed by raising the wiper 42 timed to the inkjet head 17 moving to the standby position side or the printing position side.

When nozzles become clogged and head cleaning is necessary, for example, an ink suction process can be performed to operate the pump motor while the head cap 41 is in the position sealing the nozzles to apply suction to the sealed space formed by the cavity 41c and nozzle face 17a and discharge ink from the ink nozzles.

In addition, a flushing process is also regularly performed to keep the ink droplets inside the ink nozzles in a desirable condition. This flushing process positions the inkjet head 17 to the head cap 41, and discharges a specific amount of ink from all nozzles of the inkjet head 17 into the cavity 41c in the head cap 41 in a non-printing operation. A nozzle recovery process that discharges a larger volume of ink droplets at one time than are discharged in the regular flushing process can also be performed as desired to clean the head and restore clogged nozzles.

The cleaning process could include any one of the wiping process, ink suction process, and flushing process, or a combination of these processes.

A nozzle check process that inspects the ink ejection state of the ink nozzles may also be performed before these cleaning processes are performed. Whether nozzle cleaning is necessary is determined based on the result of this nozzle check, and a nozzle cleaning process is performed as needed.

To perform this nozzle check, the head cleaning mechanism 40 also includes a nozzle check mechanism for detecting defective nozzles. More specifically, an absorbent member 41d for absorbing the discharged waste ink, and a conductor 41e that is electrically conductive with the absorbent member 41d, are disposed in the cavity 41c. An electrical signal flowing through the conductor 41e is extracted through a wire, for example. This configuration enables discharging charged ink droplets from each nozzle of the inkjet head 17, and extracting a signal denoting the change in current produced when charged ink droplets land on the absorbent member 41d. A nozzle is recognized as defective when the detection signal (the signal denoting the change) is less than or equal to a specific threshold value when the nozzle is driven to eject an ink droplet onto the absorbent member 41d. Other methods of detecting defective nozzles can also be used, including methods that use optical means such as a laser to detect ejected ink droplets.

The nozzle check process more specifically discharges charged ink droplets from the nozzles of the inkjet head 17, and inspects the discharge state of ink droplets from the tested nozzle surface based on a signal denoting the current change when ink droplets land on the absorbent member 41d in the cavity 41c. When the nozzle check process is performed, the head cap 41 is positioned so that the gap L1 between the nozzle face 17a and the edge part 41b of the head cap 41, and the gap L2 between the nozzle face 17a and the surface of the absorbent member 41d, are specific dimensions, and the inkjet head 17 side is grounded so there is a specific potential difference between the inkjet head 17 and head cap 41, and voltage is applied to the head cap 41 side to create a specific field state. The ink droplets discharged from the inkjet head 17 are charged by this field to carry a specific charge until landing. When the ink droplets land, the charge flows to the conductor 41e. As a result, the ink droplet discharge state can be inspected with good precision.

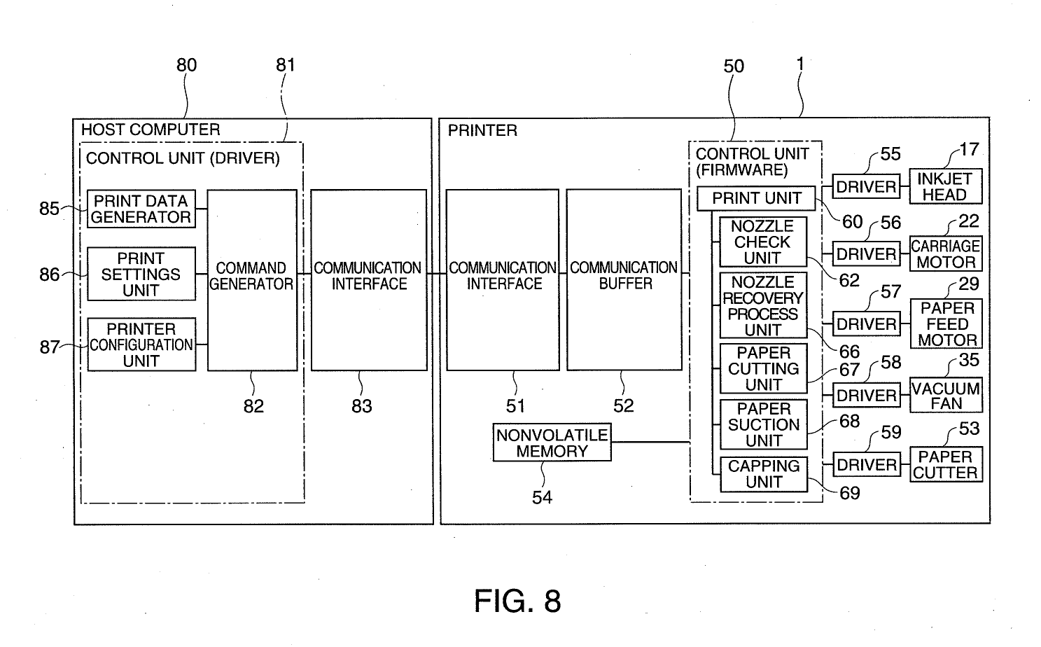

As shown in FIG. 8, the control system of the printer 1 is built around a control unit 50 that includes a CPU, ROM, and RAM. Print data from a host computer 80 is input to the control unit 50 through a communication interface 51 and communication buffer 52. Nonvolatile memory 54 such as flash ROM is connected to the control unit 50, and the nonvolatile memory 54 functions as a buffer storing converted print data and various settings.

The inkjet head 17, carriage motor 22, paper feed motor 29, vacuum fan 35, and paper cutter 53 are connected to the output side of the control unit 50 through respective drivers 55 to 59. The control unit 50 also has a print unit 60, nozzle check unit 62, nozzle recovery process unit 66, 67, paper suction unit 68, and capping unit 69.

The print unit 60 controls driving the carriage motor 22 and paper feed motor 29 to print on the recording paper 10 based on the print data.

The nozzle check unit 62 executes a nozzle check process that determines if ink droplets are ejected normally from each ink nozzle based on the change in current signals obtained from the conductor 41e of the nozzle check mechanism.

If ink droplets are not ejected normally from each ink nozzle, the nozzle recovery process unit 66 executes a nozzle recovery process to restore the ink droplet discharge state of each ink nozzle to normal. More specifically, the nozzle recovery process unit 66 controls driving the head cleaning mechanism 40 to perform the operation that suctions ink from the ink nozzles. The nozzle recovery process unit 66 may also control driving the carriage motor 22 and head cleaning mechanism 40 to wipe the inkjet head 17 nozzle face 17a with the wiper 42.

The paper cutting unit 67 drives the paper cutter 53 disposed to the paper exit 4 to cut the printed portion of the recording paper 10 discharged from the paper exit 4.

The paper suction unit 68 suctions air from the suction holes 34 and pulls the recording paper 10 conveyed over the vacuum platen 8 surface 8a to the surface 8a by operating the vacuum fan 35 of the recording paper suction mechanism.

When a print job ends and the inkjet head 17 is waiting at the standby position, the capping unit 69 controls driving the head cleaning mechanism 40 to move the head cap 41 to where the edge part 41b touches the area around the nozzle face 17a to seal the nozzles. This inhibits the ink in the nozzles from increasing in viscosity and nozzles becoming clogged while waiting to print.

The host computer 80 is a host device connected to the printer 1, and the control unit 81 (printer driver) of the host computer 80 includes a CPU, ROM, and RAM. Print data is sent from the host computer 80 to the printer 1 through a command generator 82 and communication interface 83.

The control unit 81 includes a print data generator 85, print settings unit 86, and printer configuration unit 87. The print data generator 85 produces print data from input images and text. The print settings unit 86 sets the number of copies, print quality, and other settings.

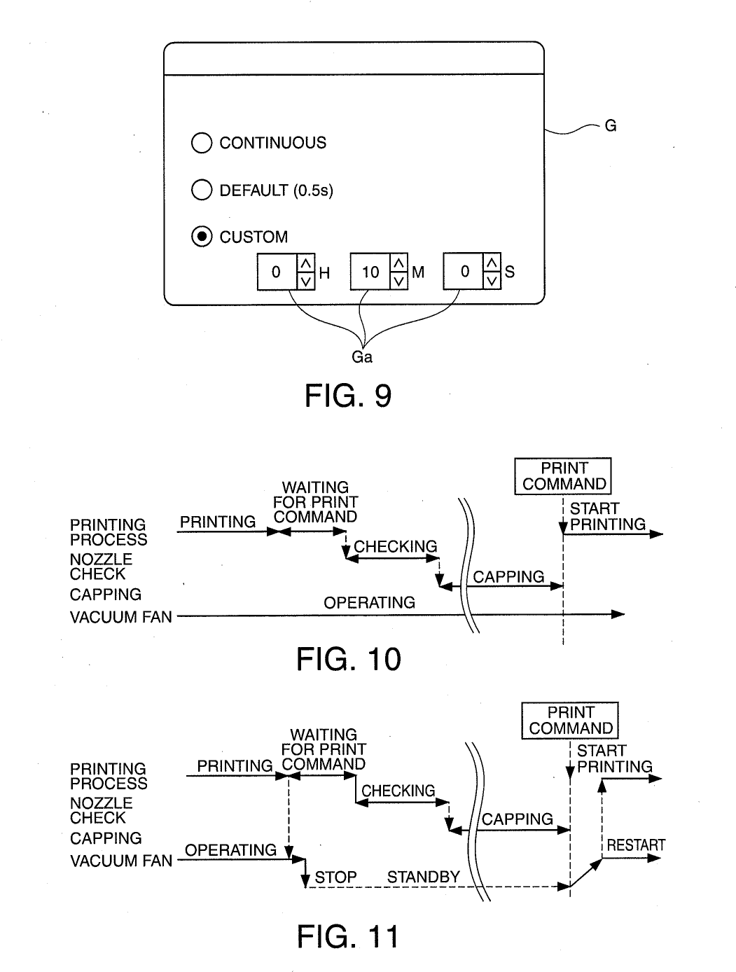

The printer configuration unit 87 configures settings such as the operating state (such as continuous or not) of the vacuum fan 35 of the recording paper suction mechanism in the printer 1. More specifically, as shown in FIG. 9, a selection window G with a GUI is presented on the display of the host computer 80 so that the user can select the operating mode of the vacuum fan 35 from among the choices shown in the selection window G. In this embodiment these choices are continuous, default, and custom. Note that the default setting sets the delay until the vacuum fan 35 turns off to 0.5 second in this embodiment of the invention. The user can thus configure this setting while checking the setting in a window presented on the host computer 80 display.

The printer 1 is set to the continuous operating mode if CONTINUOUS is selected by the printer configuration unit 87 of the host computer 80 control unit 81, to the default mode if DEFAULT is selected, and to a user-defined delay mode if CUSTOM is selected. The selection window G includes hour (H), minute (M), and second (S) selection units Ga in the CUSTOM configuration area, and when the user selects CUSTOM, the user can also set the delay time until the vacuum fan 35 stops using the selection units Ga.

When the printer 1 receives a print command and print data from the host computer 80, the vacuum fan 35 of the recording paper suction mechanism is operated by the paper suction unit 68, air is pulled through the suction holes 34, and the recording paper 10 conveyed over the vacuum platen 8 surface 8a is pulled to the platen surface 8a. Ink droplets are then ejected from the ink nozzles of the inkjet head 17 by the print unit 60 to print on the recording paper 10 thus held to the vacuum platen 8. The printed recording paper 10 is then discharged from the paper exit 4, and is cut with the paper cutter 53 by the paper cutting unit 67.

When printing the specified number of copies (such as 10) is completed, the printer 1 waits in the mode set by the printer configuration unit 87 of the host computer 80.

Control by the control unit 50 during standby in each mode is described next.

### Continuous Mode

In the continuous mode, the vacuum fan 35 does not stop and continues operating even after printing the specified number of copies is completed as shown in FIG. 10.

In addition, after a print data delay time (such as 3 seconds) in which the printer 1 waits after printing ends to see if additional print data was sent, the nozzle check unit 62 performs the nozzle check process and the capping unit 69 then caps the nozzle face 17a of the inkjet head 17, which was moved to the standby position, with the head cap 41.

When print data and a print command are sent from the host computer 80 to the printer 1 in the standby mode, the print unit 60 starts printing to the recording paper 10.

Because the vacuum fan 35 continues operating in the continuous mode even when the printer 1 is in the standby mode, a startup time of several seconds until the stopped vacuum fan 35 starts, the recording paper 10 is held firmly to the vacuum platen 8, and printing can start can be eliminated. However, because the vacuum fan 35 operates continuously until the next print command is received, noise created by the sound of the vacuum fan 35 operating is always present and power consumption by the vacuum fan 35 increases.

### Default Mode

In the default mode the vacuum fan 35 stops soon (approximately 0.5 second) after printing the specified number of copies is completed as shown in FIG. 11. In addition, after a print data delay time (such as 3 seconds) in which the printer 1 waits after printing ends to see if additional print data was sent, the nozzle check unit 62 performs the nozzle check process and the capping unit 69 then caps the nozzle face 17a of the inkjet head 17, which was moved to the standby position, with the head cap 41.

When print data and a print command are sent from the host computer 80 to the printer 1 in the standby mode, the paper suction unit 68 operates the vacuum fan 35, and after the recording paper 10 is held firmly to the vacuum platen 8 by the vacuum fan 35, the print unit 60 starts printing to the recording paper 10.

Because the vacuum fan 35 stops soon after the printer 1 enters the standby mode when in the default mode, noise and power consumption by the vacuum fan 35 can be suppressed. However, because a startup time of several seconds is required when the printer 1 starts printing from the standby mode so that the vacuum fan 35 can start operating and pull the recording paper 10 to the platen and printing can start, the start of printing is delayed after the print command is received, and throughput drops.

### Custom Mode

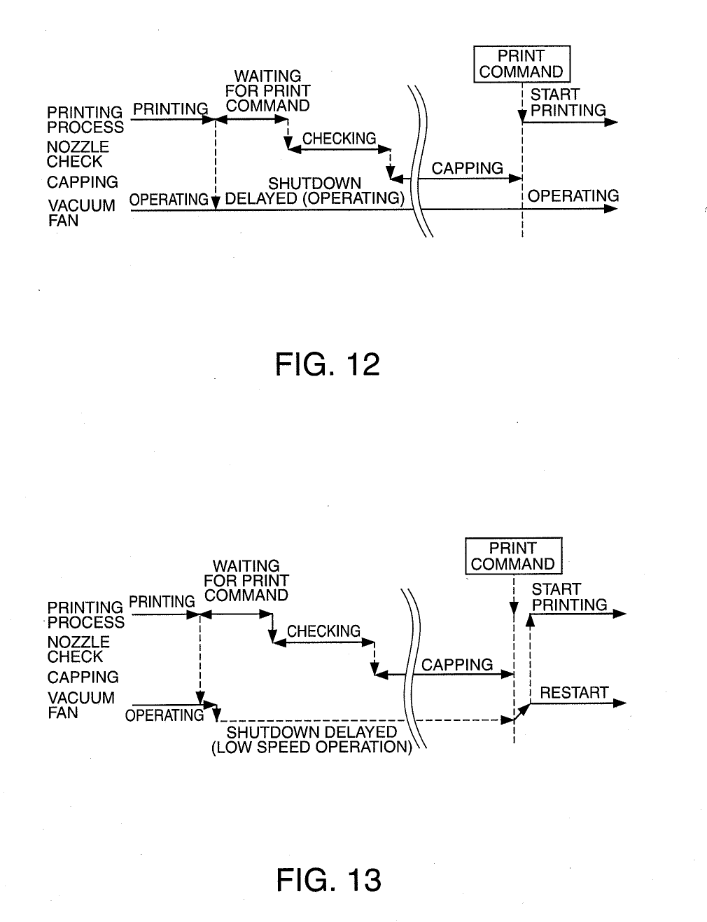

In the custom mode, the vacuum fan 35 continues operating after printing the specified number of copies ends, and does not stop until the delay time set by the selection units Ga of the selection window G for turning the vacuum fan 35 off passes as shown in FIG. 12.

In addition, after a print data delay time (such as 3 seconds) in which the printer 1 waits after printing ends to see if additional print data was sent, the nozzle check unit 62 performs the nozzle check process and the capping unit 69 then caps the nozzle face 17a of the inkjet head 17, which was moved to the standby position, with the head cap 41.

If print data and a print command are sent from the host computer 80 to the printer 1 while the vacuum fan 35 is operating in this delay time, the print unit 60 starts printing to the recording paper 10.

When print data is sent in this custom mode during the delay time set with the selection units Ga, the vacuum fan 35 does not stop and printing starts soon after the print data is sent. The startup time of several seconds required for the vacuum fan 35 to start operating and pull the recording paper 10 to the platen so that printing can start can therefore be eliminated.

Note that if print data is not sent during the delay time before the vacuum fan 35 stops, the vacuum fan 35 stops operating. As a result, power consumption can thereafter be reduced. As in the default mode, therefore, when print data is then sent, the paper suction unit 68 operates the vacuum fan 35, and after the recording paper 10 is held firmly to the vacuum platen 8 by the vacuum fan 35, the print unit 60 starts printing to the recording paper 10.

As described above, this embodiment of the invention enables freely setting the delay time until the vacuum fan 35 stops operating according to the working conditions of the printer 1. If the user shortens the delay time to fit the user's work, noise and power consumption by the vacuum fan 35 can be suppressed. In addition, if the user increases the delay time, the startup time required for the vacuum fan 35 to resume operating when printing starts can be eliminated and throughput can be improved. Printing can thus be done efficiently, work efficiency can be greatly improved, and the recording paper 10 can be pulled to the vacuum platen 8 side to enable printing with high precision.

In other words, the vacuum fan 35 can be prevented from repeatedly turning off and on when print requests are output intermittently from the host computer 80, and work throughput can be improved. In addition, the delay time can be desirably set in 1 second increments from 1 second to 43,200 seconds (=12 hours) using the selection units Ga in the selection window G, thus increasing the freedom of customization while balancing work efficiency with consideration for the environment (suppressing noise and power consumption).

Note that during the delay time set in the custom mode the vacuum fan 35 operates in the same way as in the printing process, but the operating speed of the vacuum fan 35 during this delay could be reduced from the operating speed used during the printing process as shown in FIG. 13. This enables suppressing vacuum fan 35 noise and power consumption during the delay.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A method of controlling a printer that, when printing print data received from a host computer to paper, pulls the back side of the printed surface of the paper that is printed to the platen side by a vacuum fan, comprising a step of:
setting a delay time until stopping operation of the vacuum fan after printing ends based on input data from the host computer.

2. The method of controlling a printer described in claim 1, wherein:
printing starts without stopping operation of the vacuum fan when a print request is received from the host computer during the delay time.

3. The method of controlling a printer described in claim 1 or 2, wherein:
the operating speed of the vacuum fan is slower during the delay time than when printing.

4. A recording medium recording a printer driver that enables setting a delay time until stopping operation of the vacuum fan after printing ends in a printer that, when printing print data received from a host computer to paper, pulls the back side of the printed surface of the paper that is printed to the platen side by a vacuum fan.

5. A printer that, when printing print data received from a host computer to paper, pulls the back side of the printed surface of the paper that is printed to the platen side by a vacuum fan, comprising:
a control unit that pulls the paper to the platen side by the vacuum fan and prints when a print command and print data are received from the host computer, and can control a delay time until the vacuum fan stops after printing ends.

6. The printer described in claim 5, wherein:
the control unit applies control to print without stopping operation of the vacuum fan when a print request is received from the host computer during the delay time.

7. The printer described in claim 5, wherein:
the control unit executes control that sets the operating speed of the vacuum fan slower during the delay time than when printing.
